(19) United States
(12) Patent Application Publication
(10) Pub. No.: US 2023/0122781 A1
(43) Pub. Date: Apr. 20, 2023

(54) Low-Latency Buffer Storage Of Static Datasets For Query Operation Optimization

(71) Applicant: NetSpring Data, Inc., Redwood City, CA (US)

(72) Inventors: Satyam Shekhar, San Jose, CA (US); Priyendra Singh Deshwal, Saratoga, CA (US); Abhishek Rai, Palo Alto, CA (US)

(21) Appl. No.: 17/969,245

(22) Filed: Oct. 19, 2022

Related U.S. Application Data
(60) Provisional application No. 63/257,450, filed on Oct. 19, 2021.

(51) Int. Cl. G06F 16/903

(52) U.S. Cl. CPC G06F 16/90335

(57) ABSTRACT

Data corresponding to first and second datasets are stored within a low-latency buffer. A first query is executed by computing a join between the first and second datasets to produce a first output using the data stored in the low-latency buffer. Following execution of the first query, data corresponding to the first dataset is maintained in the low-latency buffer and data corresponding to the second dataset is purged from the low-latency buffer based on a determination that the first dataset is a static dataset and a determination that the second dataset is not a static dataset. A second query is then executed using the first dataset to produce a second output while the data corresponding to the first dataset is maintained in the low-latency buffer. The second query may be the same as or different from the first query.

### CROSS-REFERENCE TO RELATED APPLICATION(S)

This applications claims the benefit of U.S. Provisional Application No. 63/257,450, filed Oct. 19, 2021, the entire disclosure of which is herein incorporated by reference.

### BACKGROUND

Modern enterprises are increasingly data-focused and reliant on data analysis such as to manage and automate operations and to identify operational inefficiencies and opportunities. The datasets used are often extremely large and continue growing each day. The data may be state-based, such as historical data with values measurably in one state or another, event-based, such as real-time data with values that change over time, or some combination thereof. Given the challenges in utilizing voluminous and complex data, many enterprises use sophisticated software tools configured to collect, store, query, and analyze historical or real-time data.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a computing system which includes a data platform.

FIG. 2 is a block diagram of an example internal configuration of a computing device usable with a computing system.

FIG. 3 is a block diagram of an example of a data platform.

FIG. 4 is a block diagram of an example process in the context of a data platform.

FIG. 5 is a block diagram of an example of a data store management component of a data platform.

FIG. 6 is a block diagram of an example of a query processor component of a data platform.

FIG. 7 is a block diagram of an example of a query execution pipeline.

FIG. 8 is a block diagram of an example of parallel processing of ingested data for query processing and storage.

FIG. 9 is a block diagram of an example of buffer storage of static datasets for query operation optimization

FIG. 10 is a block diagram of an example of access to ingested data within a memory buffer for query execution.

FIG. 11 is a flowchart of an example of a technique for low-latency buffer storage of static datasets for query operation optimization.

FIG. 12 is a flowchart of an example of a technique for low-latency access to ingested data for query execution.

### DETAILED DESCRIPTION

Aspects of this disclosure relate to a data platform capable of ingesting, processing, querying, analyzing batch and streaming data, or combinations thereof. In some implementation a data platform may be implemented as or used as an operational intelligence platform. For example, an operational intelligence platform may include a suite of development and runtime software tools that monitor, alert and support interactive decision making by providing data and analytics about current conditions. Such platforms may have adapters to receive and send data; event processing logic to detect threats and opportunities; rule processing; analytics; dashboards; alerting facilities; and capabilities to trigger responses in applications, devices or workflow tools; or combinations thereof. Such platforms may apply to the operational aspects of a business. Business operations are activities such as those that produce, deliver or directly enable goods, services and information products. Applications built on operations intelligence platforms may work at the oversight level; in some implementations they may not directly control work at a detailed level.

Existing software used with complex and voluminous data has various shortcomings that this disclosure and implementations of a data platform described herein address. For example, existing solutions may not be optimally designed for workloads that include both batch and streaming data, may include separately designed and/or implemented components that operate together in a sub-optimal way, may require data expressions that are unnecessarily complex and unsuited to expression re-use, or combinations thereof.

Implementations of a data platform may include a query generation component that takes as input a data expression according to a simplified query language. The simplified query language allows for the omission of join qualifications in the typical case where join qualifications are unambiguously obtainable from a data schema that pertain to the datasets being queried. The query generation component may include parsing the data expression into a tree of “quads” which may take the form of an abstract syntax tree and may include an intermediate step of transforming the data expression into prefix notation. A schema to which the data expression pertains may be processed (or pre-processed) to generate a base derivation graph having nodes for datasets in the schema and edges describing derivation relationships between datasets in the schema. A derivation graph for the data expression is built from the base derivation graph, for example by adding nodes and edges for quads by recursively processing the tree of quads. The derivation graph may then be queried according to one or more grains (e.g., dimensions by which the quads are to be grouped) of the quads in the tree of quads to obtain relevant derivation relationships that can be utilized to generate join relationships between the quads in order to produce a query in a complex query language (e.g., structured query language (SQL), such as standardized in ISO/IEC 9075).

Implementations of a data platform may also include a data ingress component that obtains data and a data store management component that stores data and makes data available to a query processing component. For example, the data ingress component may obtain data regarding the operation of software and hardware relating to a company's information technology operations using local agents or by accessing APIs through which such data may be obtained. For example, the data store management component may store and make data available to the query generation component in parallel, and/or may make data available using memory mapping techniques so as to avoid copying of the data in memory. In another example, the data store management component may predictively keep certain subsets of data in memory longer based on patterns of past usage of datasets to which the subsets of data pertain. In another example, the data store management component may determine whether to store and/or maintain subsets data in local storage, cold storage, or some other form of storage based on an assessment of likelihood of whether respective subsets are likely to be queried based on patterns of past usage of datasets.

Implementations of a data platform may also include a query processing component that takes as input a structured query expression (e.g., from the query generation component) and executes the structured query expression against ingested data (e.g., from the data store management component) to produce query results. For example, the query processing component may access the ingested data using a shared memory provided by the data store management component. In another example, the query processing component may share metadata regarding queries with the data store management component to permit the data store management component to better evaluate where to store and how long to keep in memory ingested data.

More specifically with respect to the implementations of the data store management and query processing components, existing query processing software relies upon external data store management software, and vice versa. Existing data processing solutions thus do not include both a data store management component and a query processing component. For example, query processing software may leverage external data management software such as Snowflake to process and store data to use for query execution. In another example, data management software may leverage external query processing software such as Apache Flink® to execute queries based on stored data. However, this separation results in numerous drawbacks due to the disparate designs and specifications of the software. For example, the use of query processing software with external data management software requires data to be written to disk before it can be made available for querying.

Furthermore, the design differences in and rigidity of use of external software prevent optimizations which may otherwise be available between data management and query processing software, such as by enabling changes to in-memory data storage based on operations at a query execution pipeline. For example, the inability of external data management software to natively obtain information about queries being executed adds latency into the query execution process by requiring all data to be obtained from disk at the time of query execution rather than maintained in-memory beforehand. In another example, existing software which performs joins in streaming query systems, which use constantly-updating datasets, typically re-compute full joins with each dataset update rather than performing incremental updates based on in-memory maintenance of datasets which do not change or are less likely to change.

Implementations of this disclosure address problems such as these using optimizations between data store management components and query processing components of a data platform. The optimizations include query operations performable using a static dataset maintained within a low-latency memory buffer (e.g., incremental join optimizations which limit the re-computations performed for an incremental join based on a static dataset being stored in a low-latency memory buffer), cross-optimizations which use recency of use information to purge ingested data within a low-latency memory buffer to a warm or cold storage after that ingested data is accessed within the memory buffer for query execution, and combinations thereof.

Referring first to query operation optimizations, according to implementations of this disclosure, data corresponding to first and second datasets are stored within a low-latency buffer. A first query is executed by computing a join between the first and second datasets to produce a first output using the data stored in the low-latency buffer. Following execution of the first query, data corresponding to the first dataset is maintained in the low-latency buffer and data corresponding to the second dataset is purged from the low-latency buffer based on a determination that the first dataset is a static dataset and a determination that the second dataset is not a static dataset. A second query is then executed using the first dataset to produce a second output while the data corresponding to the first dataset is maintained in the low-latency buffer. The second query may be the same or similar as or different from the first query. For example, the second query may be modified from the first query in order to include data added to the second dataset subsequent to the execution of the first query and to exclude data of the second dataset included in the first output.

Referring next to cross-optimizations, according to implementations of this disclosure, data is ingested from one or more data sources directly into a low-latency memory buffer. In response to ingesting the data, the ingested data is accessed within the low-latency memory buffer to execute a query without requiring creation of a copy of the ingested data and thus without first writing the ingested data to a warm or cold storage. At some point subsequent to executing the query, the ingested data may be purged from the low-latency memory buffer, such as based on a recency of use of a dataset corresponding to the ingested data for query execution. The purging of the ingested data moves the ingested data to a warm or cold storage and clears space in the low-latency memory buffer for later ingested data to be accessed directly within the memory buffer for query execution also without requiring creation of a copy thereof.

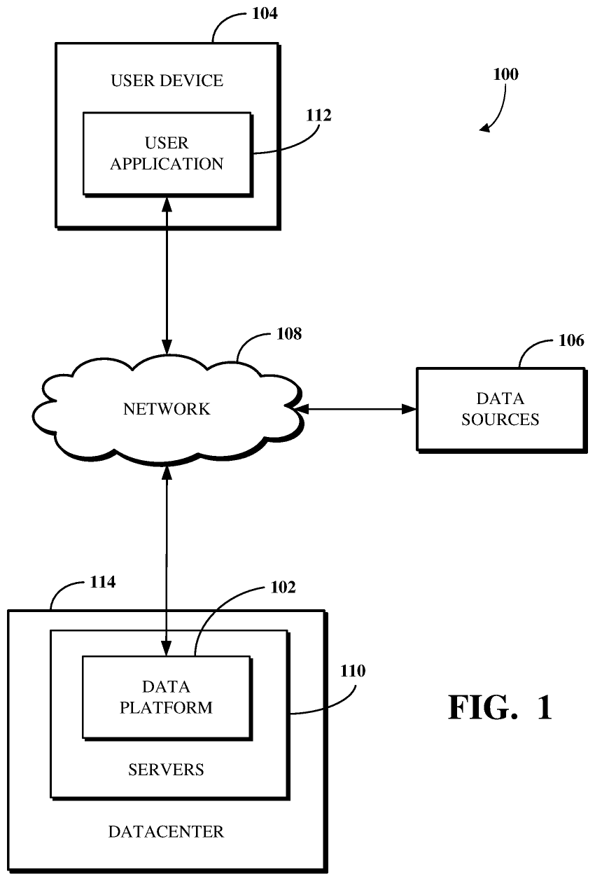

To describe some implementations in greater detail, reference is first made to examples of hardware and software structures used to implement a system for low-latency buffer storage of static datasets for query operation optimization. FIG. 1 is a block diagram of an example of a computing system 100 which includes a data platform 102. The data platform 102 includes software for continuous monitoring of large scale streaming and batch data such as to generate near real-time alerts. A user of the data platform 102, such as a user of a user device 104, can configure the data platform 102 to obtain data from one or more data sources 106 over a network 108. The user can define metrics and rules in the data platform 102 software that are evaluated on a periodic or event-driven basis to detect expected or unexpected data patterns, constraint violations, or data anomalies using the data obtained from the data sources 106. Where applicable, the data platform 102 may notify the user about conditions such as these using alerts delivered in one or more configurable manners. While the foregoing are examples of certain types of batch and streaming data that may be obtained from data sources 106, such examples are non-limiting and other types of batch or streaming data may be utilized instead or in addition.

The user device 104 is a computing device capable of accessing the data platform 102 over the network 108, which may be or include, for example, the Internet, a local area network (LAN), a wide area network (WAN), a virtual private network (VPN), or another public or private means of electronic computer communication. For example, the user device 104 may be a mobile phone, a tablet computer, a laptop computer, a notebook computer, a desktop computer, or another suitable computing device. In some cases, the user device 104 may be registered to or otherwise associated with a customer of the data platform 102. The data platform 102 may be created and/or operated by a service provider and may have one or more customers, which may each be a public entity, private entity, or another corporate entity or individual that purchases or otherwise uses software services of the data platform 102. Without limitation, the data platform 102 can support hundreds or thousands of customers, and each of the customers may be associated with or otherwise have registered to it one or more user devices, such as the user device 104.

The data sources 106 are computing devices which temporarily or permanently store data processable by the data platform 102. As shown, the data sources 106 are external to the data platform 102 and the computing aspects which implement it (i.e., the servers 110, as introduced below). The data sources 106 in at least some cases are thus computing devices operated other than by a customer of the data platform 102. For example, a data source external to the data platform 102 may be or refer to a computing device wholly or partially operated by a third party or by the service provider. Examples of such external data sources include, without limitation, instances of Apache Kafka®, Redshift®, Salesforce®, and Postgres®. In some implementations, however, a data source 106 may be or refer to a computing device operated by a customer of the data platform 102. For example, the data source 106 may be a computing device which stores internally generated or maintained transaction, user, or other operational data of the customer. In such a case, the data source 106 In some implementations, external data sources 106 may communicate with the data platform over a first network 108 (e.g., a WAN) and internal data sources 106 may communicate with the data platform 102 over a second network 108 (e.g., a LAN).

The data platform 102 is implemented using one or more servers 110, including one or more application servers and database servers. The servers 110 can each be a computing device or system, which can include one or more computing devices, such as a desktop computer, a server computer, or another computer capable of operating as a server, or a combination thereof. In some implementations, one or more of the servers 110 can be a software implemented server implemented on a physical device, such as a hardware server. In some implementations, a combination of two or more of servers 110 can be implemented as a single hardware server or as a single software server implemented on a single hardware server. For example, an application server and a database server can be implemented as a single hardware server or as a single software server implemented on a single hardware server. In some implementations, the servers 110 can include servers other than application servers and database servers, for example, media servers, proxy servers, and/or web servers.

An application server runs software services deliverable to user devices such as the user device 104. For example, the application servers of the servers 110 can implement all or a portion of the non-data store management-related software functionality of the data platform 102, including, without limitation, data ingress software, analytical configuration software, query processing software, and query generation software. The application servers may, for example, each be or include a unitary Java Virtual Machine (JVM).

In some implementations, an application server of the servers 110 can include an application node, which can be a process executed on the application server. For example, and without limitation, the application node can be executed in order to deliver software services to user devices such as the user device 104 as part of a software application of the data platform 102. The application node can be implemented using processing threads, virtual machine instantiations, or other computing features of the application server. In some such implementations, the application server can include a suitable number of application nodes, depending upon a system load or other characteristics associated with the application server. For example, and without limitation, the application server can include two or more nodes forming a node cluster. In some such implementations, the application nodes implemented on a single application server can run on different hardware servers.

A database server stores, manages, or otherwise provides data for delivering software services of the data platform 102 to user devices such as the user device 104. In particular, a database server of the servers 110 may implement one or more databases, tables, or other information sources suitable for use with a software application implemented using an application server, as described above. The database server may include a data storage unit accessible by software executed on the application server. A database implemented by the database server may be a relational database management system (RDBMS) which uses a relational-data model to store data in some table-based structure accessible using a query language, such as SQL. In some implementations, a database implemented by the database server may be other than a RDBMS, for example, an object database, an XML database, a configuration management database (CMDB), a management information base (MIB), one or more flat files, other suitable non-transient storage mechanisms, or a combination thereof. The servers 110 can include one or more database servers, in which each database server can include one, two, three, or another suitable number of databases configured as or comprising a suitable database type or combination thereof.

An application server instantiates the subject software service of the data platform 102 using corresponding data obtained from a database server. The application servers and database servers used to implement the data platform 102 may be made available as part of a cloud computing system. The data platform 102 may be implemented in a web application configuration, a server application in a client-server configuration, or another configuration. The user device 104 accesses the data platform 102 using a user application 112. The user application 112 may be a web browser, a client application, or another type of software application.

In one example, where the data platform 102 is implemented as a web application, the user application 112 may be a web browser, such that the user device 104 may access the web application using the web browser running at the user device 104. For example, the user device 104 may access a home page for the data platform 102 from which a software service thereof may be connected to, or the user device 104 may instead access a page corresponding to a software service thereof directly within the web browser at the user device 104. The user of the user device 104 may thus interact with the software service and data thereof via the web browser.

In another example, where the data platform 102 is implemented in a client-server configuration, the user application 112 may be a client application, such that the user device 104 may run the client application for delivering functionality of at least some of the software of the data platform 102 at the user device 104, which may thus be referred to as a client device. The client application accesses a server application running at the servers 110. The server application delivers information and functionality of at least some of the software of the data platform 102 to the user device 104 via the client application.

In some implementations, the data platform 102 may be on-premises software run at a site operated by a private or public entity or individual associated with the user device 104. For example, the data sources 106 may be sources available at that site and then network 108 may be a LAN which connects the data sources 106 with the servers 110. The data platform 102 may in some such cases be used to analyze and monitor data limited to that site operator.

In some implementations, a customer instance, which may also be referred to as an instance of the data platform, can be implemented using one or more application nodes and one or more database nodes. For example, the one or more application nodes can implement a version of the software of the data platform, and databases implemented by the one or more database nodes can store data used by the version of the software of the data platform. The customer instance associated with one customer may be different from a customer instance associated with another customer. For example, the one or more application nodes and databases used to implement the platform software and associated data of a first customer may be different from the one or more application nodes and databases used to implement the platform software and associated data of a second customer. In some implementations, multiple customer instances can use one database node, such as wherein the database node includes separate catalogs or other structure for separating the data used by platform software of a first customer and platform software of a second customer.

The computing system 100 can allocate resources of a computer network using a multi-tenant or single-tenant architecture. Allocating resources in a multi-tenant architecture can include installations or instantiations of one or more servers, such as application servers, database servers, or any other server, or combination of servers, which can be shared amongst multiple customers. For example, a web server, such as a unitary Apache installation; an application server, such as a unitary JVM; or a single database server catalog, such as a unitary MySQL catalog, can handle requests from multiple customers. In some implementations of a multi-tenant architecture, an application server, a database server, or both can distinguish between and segregate data or other information of the various customers of the data platform 102.

In a single-tenant infrastructure (which can also be referred to as a multi-instance architecture), separate web servers, application servers, database servers, or combinations thereof can be provisioned for at least some customers or customer sub-units. Customers or customer sub-units can access one or more dedicated web servers, have transactions processed using one or more dedicated application servers, or have data stored in one or more dedicated database servers, catalogs, or both. Physical hardware servers can be shared such that multiple installations or instantiations of web servers, application servers, database servers, or combinations thereof can be installed on the same physical server. An installation can be allocated a portion of the physical server resources, such as random access memory (RAM), storage, communications bandwidth, or processor cycles.

A customer instance can include multiple web server instances, multiple application server instances, multiple database server instances, or a combination thereof. The server instances can be physically located on different physical servers and can share resources of the different physical servers with other server instances associated with other customer instances. In a distributed computing system, multiple customer instances can be used concurrently. Other configurations or implementations of customer instances can also be used. The use of customer instances in a single-tenant architecture can provide, for example, true data isolation from other customer instances, advanced high availability to permit continued access to customer instances in the event of a failure, flexible upgrade schedules, an increased ability to customize the customer instance, or a combination thereof.

The servers 110 are located at a datacenter 114. The datacenter 114 can represent a geographic location, which can include a facility, where the one or more servers are located. Although a single datacenter 114 including one or more servers 110 is shown, the computing system 100 can include a number of datacenters and servers or can include a configuration of datacenters and servers different from that generally illustrated in FIG. 1. For example, and without limitation, the computing system 100 can include tens of datacenters, and at least some of the datacenters can include hundreds or another suitable number of servers. In some implementations, the datacenter 114 can be associated or communicate with one or more datacenter networks or domains. In some implementations, such as where the data platform 102 is on-premises software, the datacenter 114 may be omitted.

The network 108, the datacenter 114, or another element, or combination of elements, of the system 100 can include network hardware such as routers, switches, other network devices, or combinations thereof. For example, the datacenter 114 can include a load balancer for routing traffic from the network 108 to various ones of the servers 110. The load balancer can route, or direct, computing communications traffic, such as signals or messages, to respective ones of the servers 110. For example, the load balancer can operate as a proxy, or reverse proxy, for a service, such as a service provided to user devices such as the user device 104 by the servers 110. Routing functions of the load balancer can be configured directly or via a domain name service (DNS). The load balancer can coordinate requests from user devices and can simplify access to the data platform 102 by masking the internal configuration of the datacenter 114 from the user devices. In some implementations, the load balancer can operate as a firewall, allowing or preventing communications based on configuration settings. In some implementations, the load balancer can be located outside of the datacenter 114, for example, when providing global routing for multiple datacenters. In some implementations, load balancers can be included both within and outside of the datacenter 114.

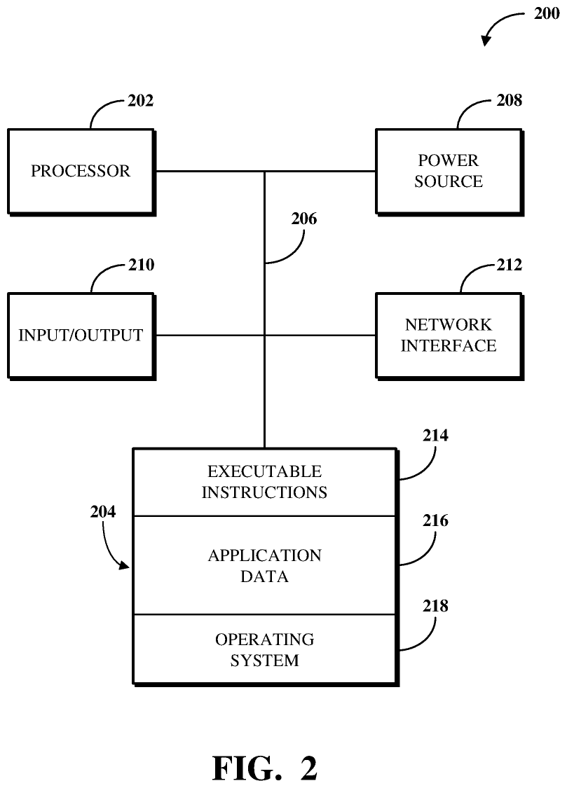

FIG. 2 is a block diagram of an example internal configuration of a computing device 200 usable with a computing system, such as the computing system 100 shown in FIG. 1. The computing device 200 may, for example, implement one or more of the user device 104 or one of the servers 110 of the computing system 100 shown in FIG. 1.

The computing device 200 includes components or units, such as a processor 202, a memory 204, a bus 206, a power source 208, input/output devices 210, a network interface 212, other suitable components, or a combination thereof. One or more of the memory 204, the power source 208, the input/output devices 210, or the network interface 212 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, now existing or hereafter developed, configured for manipulating or processing information. For example, the processor 202 can include multiple processors interconnected in one or more manners, including hardwired or networked, including wirelessly networked. For example, the operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory of the memory 204 can be random access memory (RAM) (e.g., a DRAM module, such as DDR SDRAM) or another form of volatile memory. In another example, the non-volatile memory of the memory 204 can be a disk drive, a solid state drive, flash memory, phase-change memory, or another form of non-volatile memory configured for persistent electronic information storage. Generally speaking, with currently existing memory technology, volatile hardware provides for lower latency retrieval of data and is more scarce (e.g., due to higher cost and lower storage density) and non-volatile hardware provides for higher latency retrieval of data and has greater availability (e.g., due to lower cost and high storage density). The memory 204 may also include other types of devices, now existing or hereafter developed, configured for storing data or instructions for processing by the processor 202. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 214, application data 216, and an operating system 218. The executable instructions 214 can include one or more application programs, which can be loaded or copied, in whole or in part, from non-volatile memory to volatile memory to be executed by the processor 202. For example, the executable instructions 214 can include instructions for performing some or all of the techniques of this disclosure. The application data 216 can include user data, database data (e.g., database catalogs or dictionaries), or the like. In some implementations, the application data 216 can include functional programs, such as a web browser, a web server, a database server, another program, or a combination thereof. The operating system 218 can be, for example, Microsoft Windows®, Mac OS X®, or Linux®; an operating system for a mobile device, such as a smartphone or tablet device; or an operating system for a non-mobile device, such as a mainframe computer.

The power source 208 includes a source for providing power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The input/output devices 210 include one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, or other suitable display.

The network interface 212 provides a connection or link to a network (e.g., the network 108 shown in FIG. 1). The network interface 212 can be a wired network interface or a wireless network interface. The computing device 200 can communicate with other devices via the network interface 212 using one or more network protocols, such as using Ethernet, transmission control protocol (TCP), internet protocol (IP), power line communication, an IEEE 802.X protocol (e.g., Wi-Fi, Bluetooth, ZigBee, etc.), infrared, visible light, general packet radio service (GPRS), global system for mobile communications (GSM), code-division multiple access (CDMA), Z-Wave, another protocol, or a combination thereof.

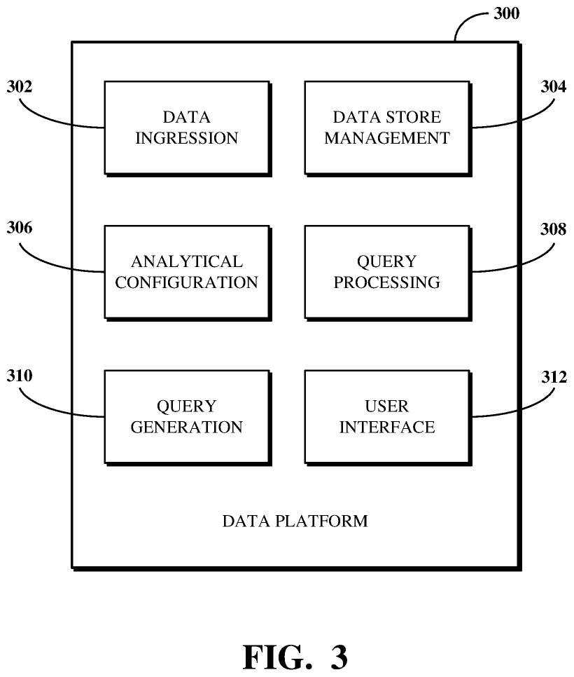

FIG. 3 is a block diagram of an example of a data platform 300, which may, for example, be the data platform 102 shown in FIG. 1. The data platform 300 is accessible by user devices, for example, the user device 104 using the web browser software 112 (or a client application, as applicable) shown in FIG. 1. The data platform 300 includes components for data and query processing and analytics. As shown, the software of the data platform 300 includes a data ingression component 302, an analytical configuration component 304, a data store management component 306, a query processing component 308, a query generation component 310, and a user interface component 312.

As used herein, the term “component” can refer to a hardware component (e.g., infrastructure, such as a switch, router, server, modem, processor, integrated circuit, input/output interface, memory, storage, power supply, biometric reader, media reader, other sensor, or the like, or combinations thereof), a software component (e.g., a platform application, web application, client application, other software application, module, tool, routine, firmware process, or other instructions executable or interpretable by or in connection with one or more hardware components, or the like, or combinations thereof), or combinations thereof. A component can also refer to a computing feature such as a document, model, plan, socket, virtual machine, or the like, or combinations thereof. A component, such as a hardware component or a software component, can refer to a physical implementation (e.g., a computing device, such as is shown in FIG. 2) or a virtual implementation (e.g., a virtual machine, container, or the like that can, for example, execute on a physical device and mimic certain characteristics of a physical device) of one or more of the foregoing.

The components 302 through 312 may be implemented using one or more servers, for example, the servers 110 of the datacenter 114 shown in FIG. 1. In particular, one or more of the components 302 through 312 may be implemented using one or more application servers and database servers. In one example, each of the components 302 through 312 can be implemented using different application server nodes and/or database server nodes. In another example, some of the components 302 through 312 can be implemented using the same application server nodes and/or database server nodes while the others are implemented using different application server nodes and/or database server nodes. In yet another example, all of the components 302 through 312 can be implemented using the same application server nodes and/or database server nodes. Although the various components of the data platform 300 generally relates to data and query processing and analytics, the components may be utilized for query processing alone, data processing alone, or other suitable activities.

The data ingression component 302 obtains raw data used by the data platform 300 from one or more data sources, for example, the data sources 106 shown in FIG. 1. The data ingression component 302 may be configured by a user of the data platform 300 to connect to the various individual data sources using forms or like user interface elements. Raw data may be obtained from a data source using one or more mechanisms. In one example, raw data may be obtained via a push mechanism using a representational state transfer (REST) application programming interface (API) configured to connect the data ingression component 302 with a REST endpoint of a data source. In another example, raw data may be obtained via a pull mechanism using a dedicated listener including a streaming data processing pipeline that reacts to events from a connected data source (e.g., new data being added to an Amazon S3® bucket, a stream of change data capture updates from Postgres®, or messages added to a Kafka® bus). A user may configure as many connections to data sources as are required to obtain the data necessary for analysis by the data platform 300. The raw data may be obtained as part of a batch dataset or a streaming dataset.

The data store management component 304 processes the raw data obtained using the data ingression component 302 as ingested data to prepare the ingested data for immediate query processing using the query processing component 310, as will be described below. For example, the data store management component 304 may be a RDBMS. In another example, the data store management component 304 may be a database management system for NoSQL data. The data store management component 304 uses blazers, worker nodes arranged in clusters, and tabloids, table masters that communicate with blazers, to store the data in tables within a tiered storage system across one or more computing devices. The tiered storage system enables storage and movement of data within local memory buffers, warm storage devices (e.g., local hard drives), and cold storage devices (e.g., cloud storage). The data store management component 304 may use SQL or another query language for data load (e.g., of data manipulation language (DML) operations) and transaction processing. The data store management component 304 allows the data platform 300 to support fast data ingestion and low latency querying over streaming and batch datasets. In particular, the data store management component 304 may enable data to be ingested at rates higher than one million rows per second and to become available for operational monitoring (e.g., by query processing) within one second or less. In one example of a relational structure implemented by the data store management component 304, ingested data is stored in blocks, blocks are stored in pages, pages are stored in shards, and shards are stored in tables.

The analytical configuration component 306 obtains metrics and rules that are evaluated on a periodic or event-driven basis to detect expected or unexpected data patterns, constraint violations, or data anomalies using the ingested data processed and stored using the data store management component 304. The analytical configuration component 306 further permits the definition of alert mechanisms for indicating events based on the processing of ingested data using the defined metrics and rules. For example, a user of the data platform 300 may define metrics for measuring a number of transactions which occur over some discrete time interval and rules for determining when data events occur based on those metrics being met or exceeded. The user may also use the analytical configuration component 306 to configure the data platform 300 to present output indicative of the defined data events in one or more forms and to one or more connected systems (for example, as Kafka® topics, Slack® channels, emails, or PagerDuty® notifications).

The query generation component 308 generates queries (e.g., as query language instructions) in a query language (e.g., SQL) from data expressions written by a user of the data platform 300 in a simplified query language. The simplified query language allows a user of the data platform 300 to manipulate data using concise and reusable expressions that do not require the user to specify join relationships which are unambiguously discernable from the schema of the underlying data. A data expression written in the simplified query language provides a higher level of abstraction which permits the application common operations to those queries, rather than manipulating the subject data itself or affirmatively describing join relationships which may become increasingly complex with the addition of additional operators.

The query generation component 308 parses the data expression into a tree of “quads” which may take the form of an abstract syntax tree and may include an intermediate step of transforming the data expression into prefix notation. A schema to which the data expression pertains may be processed (or pre-processed) to generate a base derivation graph having nodes for datasets in the schema and edges describing derivation relationships between datasets in the schema. For example, the base derivation graph may be generated or updated when the schema is updated. A derivation graph for the data expression is built from the base derivation graph, for example by adding nodes and edges for quads by recursively processing the tree of quads. The derivation graph may then be queried according to one or more grains (e.g., dimensions by which the quads are to be grouped) of the quads in the tree of quads to obtain relevant derivation relationships that can be utilized to generate join relationships between the quads in order to produce a query in a complex query language (e.g., SQL, such as standardized in ISO/IEC 9075).

The quads are aggregated based on grains representing one or more dimensions of the data represented by the quads. As such, the concept of derivability as used herein may be understood to refer to whether first data associated with a first grain is derivable using second data associated with a second grain. In this example, the first data is derivable from the second data if and only if the second data can be computed given the first data. A derivation relationship is directional in nature. The simplified query language supports quads including constant, column, and dataset quads; aggregations to a single scalar value; joins of single output quads into a wider quad with multiple outputs; unary and binary functions; slicing of an input quad, which is most commonly some form of an aggregation (e.g., sum) by one or more dimensions which are often identified as grains; and filtering. A query generated using the query generation component 308 may be a batch query or a streaming query and may be manually or automatically made available to the query processing component 310.

The query processing component 310 is a converged analytical system. For example, the converged analytical system may combine certain components that typically are siloed, such as components for operational intelligence, data architecture optimization, event management, user experience management, and the like. The converged analytical system may be configured to evaluate metrics and rules defined by a user of the data platform 300 (e.g., using the analytical configuration component 306) to detect unexpected patterns, constraint violations, or anomalies identified by executing batch and streaming queries over rapidly changing datasets (e.g., millions of updates per second). The query processing component 310 executes queries, such as those generated from simplified query language data expressions using the query generation component 308, to determine query results usable for analytical and monitoring purposes, as described above. The query processing component 310 processes an input query to determine a logical plan for executing the query, and then processes the logical plan to determine a physical plan for executing the query. The logical plan is a tree of relational operations that describes the computations required for a query to execute. The physical plan includes a network of compute nodes instantiated as a query execution pipeline based on the tree of relational operations. The query execution pipeline is a hierarchically arranged pipeline which includes faucets and turbines. A faucet is a temporary holding point for data to be processed by one or more downstream turbines. A turbine is a compute node that performs some part of the computation for executing a subject query. Faucets regulate the flow of logical shard data indicating how a collection of data being processed is consumed for execution to turbines. Accordingly, a query execution pipeline starts with a source faucet at a highest level, ends with a downstream faucet at a lowest level, and has at least one intermediate level of turbines (and intermediate faucets, if there is more than one intermediate level of turbines) in which an upstream faucet passes information as input to a turbine which in turns passes output information to a downstream faucet at the next level. The process repeats until the downstream faucet at the lowest level is reached—this data is the output of the query. The output of the query processing component 310 for a batch query is a one-time result value. The output of the query processing component 310 for a streaming query is a result value which is aggregated with later-obtained local results on a discrete time interval basis.

The user interface component 312 includes elements configured across one or more sections of the data platform 300 (e.g., webpages at which the components 302 through 310 is made available) for interaction by a user of the data platform 300. The user interface component 312 may include one or more graphical user interfaces (GUI) of the data platform 300 generated and output for display as part of the components 302 through 310. For example, the data can contain rendering instructions for bounded graphical display regions, such as windows, or pixel information representative of controls, such as buttons and drop-down menus. The rendering instructions can, for example, be in the form of hypertext markup language (HTML), standard generalized markup language (SGML), JavaScript, Jelly, AngularJS, or other text or binary instructions for generating a GUI on a display that can be used to generate pixel information. A structured data output can be provided to an input of a display of a user device, such as the user device 104, so that the elements provided on the display screen represent the underlying structure of the output data. An API may also be provided to permit interaction with the data platform 300, requests to which may be manually initiated by a user or may be generated on an automatic basis.

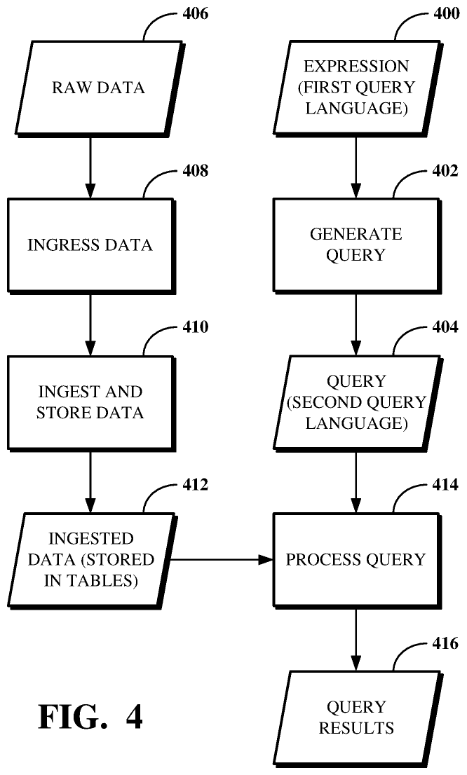

FIG. 4 is a block diagram of an example process in the context of a data platform, such as the data platform 300 shown in FIG. 3. The process includes data aspects processed and operations performed against same using components of the data platform, such as the components 302 through 312 shown in FIG. 3. The workflow may operate for batch queries and streaming queries based on a data expression written by a user of and raw data ingested by the data platform. For both types of queries, the process takes as input an expression in a simplified query language and raw data ingested from data sources as input and produces query results as output. In the case of a streaming query, the process is repeated as additional data is obtained.

An expression 400 in a first, simplified query language is provided to the data platform and is processed at query generation 402 (e.g., using the query generation component 308 shown in FIG. 3) to generate a query 404 in a second query language, such as a data query and/or data manipulation language (e.g., SQL). At some point, which may be before, after, or concurrently with the generation of the query 404, raw data 406 is obtained at data ingression 408 (e.g., using the data ingression component 302 shown in FIG. 3) from one or more data sources and is then ingested and stored 410 (e.g., using the data store management component 304 shown in FIG. 3) which results in ingested data 412 stored in one or more tables. The query 404 is obtained and the ingested data 412 is accessed within a tiered storage system (e.g., within a low-latency memory buffer) for query processing 414 (e.g., using the query processing component 310 shown in FIG. 3) such as by the execution of the query 404 against the ingested data 412 to obtain query results 416. For example, the query may be executed by dynamically generating a high level language program implementing the query and compiling the high level language program into machine language which is then executed by a processor. The query results 416 may then be used for analytical and monitoring purposes, such as according to metrics and rules defined by a user of the data platform.

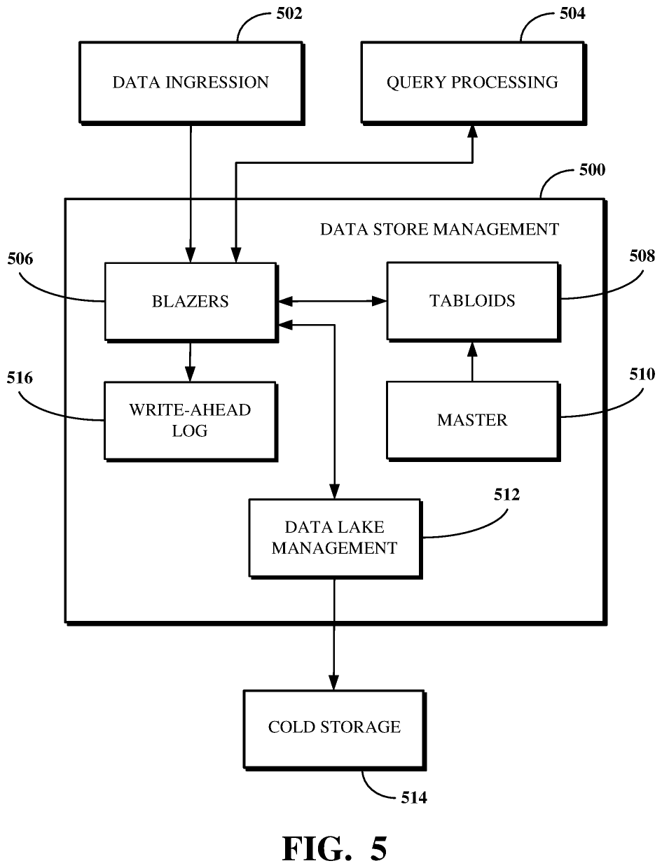

FIG. 5 is a block diagram of an example of a data store management component 500 of a data platform. For example, the data store management component 500 may be the data store management component 304 of the data platform 300 shown in FIG. 3. The data store management component 500 ingests data obtained using a data ingression component 502, which may, for example, be the data ingression component 302 shown in FIG. 3, to prepare the data for storage. Once the ingested data is available in storage, it can be accessed for query execution, such as by a query processing component 504, which may, for example, be the query processing component 308 shown in FIG. 3.

Data obtained from the data ingression component 502 are stored in tables using blazers 506 and tabloids 508. Blazers 506 are server nodes (e.g., database server nodes) arranged in clusters and which perform computations against data stored within tables. Tabloids 508 are server nodes that maintain the tables and coordinate operations performed by blazers 506 of a cluster. A master 510 is a highest level controller entity in a cluster and schedules shards of tables maintained by a tabloid 508 of a given cluster across available blazers 506 of that cluster. The mapping of tables to tabloids 508 is periodically computed and published by the master 510 in a directory. The directory is used to direct data obtained from the data ingression component 502 to the appropriate table. A cluster may have one master 510, one or more tabloids 508 and one or more blazers 506. For example, a cluster may have multiple tabloids 508 and blazers 506.

A table maintained by a tabloid 508 includes one or more shards. The organization of shards for a table may be random, such as in which rows of the table are randomly mapped to various shards, or semantic, such as where a given row is mapped to a specific shard using a sharding function. Each shard includes one or more pages, which may be fixed-size collections of rows within a shard. For example, a page may be sized to include one million or more rows. Each page includes one or more columns of data which may be independently stored and retrieved. The data is stored in blocks, which are atomic storage units for columns. In that schemas may change over time, a table maintained by a tabloid 508 may also be associated with a version which represents a specific schema of the table.

The blazers 506 of a cluster ingest, such as by writing and updating, table data into a data lake managed using a data lake management component 514. The data lake is a storage repository that maintains the data as ingested within one of three tiers of storage, including a first tier corresponding to local memory at a blazer 506 (e.g., a memory buffer of a device implementing a blazer 506), a second tier corresponding to warm storage at a blazer 506 (e.g., a local hard drive, for example, a solid state drive, of a device implementing a blazer 506), and a third tier corresponding to a cold storage 514 (e.g., a cloud server storage or a local server drive accessible by a blazer 506). Data is moved between the tiers of storage in a manner designed to provide high availability and low latency access by the query processing component 504. In some implementations, the data lake and/or the data lake management component 512 may be implemented using an immutable distributed transaction ledger system, such as BlockDB. The data lake management component 514 may use a cache prioritization scheme to manage data storage across one or more of the tiers of storage based on queries executed by the query processing component 504. For example, data may be moved into memory at a device implementing a blazer 506 based on a recency of use of the data for query execution and/or based on a frequency of use of that data for query execution over some period of time. Prioritized datasets may be maintained within local memory whereas datasets which have either not been recently used which are infrequently used within some period of time may be maintained within warm storage at a blazer 506 or the cold storage 514.

Mutations to a table maintained by a tabloid 508, such as by the ingestion of data or other operations performed by a blazer 506, are marked with sequence numbers. A row added to a table based on a mutation (e.g., a data manipulation language (DML) operation or transaction) may be annotated with the sequence number of that mutation. In some implementations, a row may be immutable once it is written to a table. Different sequence numbers may be used to indicate different mutations. For example, a begin sequence number (BSN) may be annotated to a table row for insert mutations, an end sequence number (ESN) may be annotated to the row for delete mutations, and updates may be supported based on a combination of a BSN and ESN. A query executed by the query processing component 504 is processed against a live sequence number (LSN) of a table maintained by a tabloid 508. A LSN refers to the sequence number annotated to a last row of the table and therefore is the sequence number for the most current version of the table. Given that tables may constantly be updating as new data is obtained from the data ingression component 502, the LSN which is used to serve data for query execution is greater than or equal to a latest BSN for the table and also less than an ESN for the table.

The tabloids 508 coordinate table-level workflows (e.g., resharding, compacting, and transactions) serve salient information about maintained tables (e.g., schema, shard information, metadata, and LSNs) for use by other aspects of the data store management component 500 and/or the query processing component 504. The tabloids 508 orchestrate the application of DML operation mutations that impact multiple shards of a table. Non-transactional operations that are specific to a given shard are directly forwarded to the blazer 506 associated with that shard according to a mapping defined within the directory published by the master 510. The tabloid 508 which forwards an operation to a blazer 506 allocates a sequence number to be applied by the blazer 506 to the row affected by the operation. For example, the blazer 506 may request the sequence number from the tabloid 508. The blazer 506 persists the operation to a write-ahead log 516 for durability. The write-ahead log 516 maintains records of operations performed by the blazers 506 on a per-shard basis to enable the blazers 506 to recreate their in-memory states in the event of a planned event or crash which temporarily restricts operation by the data store management component 500. In some implementations, the write-ahead log 516 may be implemented using a software bus, such as Apache Kafka®.

The processes performed by the data store management component 500 in response to or otherwise as part of a query execution process performed by the query processing component 504 may differ between DML operations performed by a single blazer 506 and transactions atomically applied across multiple blazers 506. For DML operations, an incoming DML operation is received at a blazer 506 and written into the write-ahead log 516. The blazer 506 requests a sequence number for the DML operation from a tabloid 508 which maintains the subject table. Data necessary to process the DML operation is loaded into memory, or is determined to already be in memory, at the device implementing the blazer 506 to prepare the blazer 506 for query processing. The blazer 506 applies the sequence number requested and obtained from the tabloid 508 to the DML operation and transmits an update indicating the application of that sequence number to the tabloid 508. The tabloid 508 updates the LSN for the subject table based on the application of the sequence number by the blazer 506. The data to use for the DML operation is now available. For transactions, an incoming transaction is received at a tabloid 508 and written into the write-ahead log 516. The tabloid 508 assigns a sequence number to the transaction. Data necessary to process the transaction is loaded into memory, or is determined to already be in memory, at devices implementing the blazers 506 which are mapped to shards within the subject table. Those blazers 506 apply the sequence number to their shards and transmit and update indicating the application thereof to the tabloid 508. The tabloid 508 updates the LSN for the subject table based on the application of the sequence number by the blazers 506. The data to use for the transaction is now available.

The data store management component 500 supports recovery processes for restarting blazers 506 and tabloids 508. For blazers 506, where there are no backup replicas available for a shard mapped to a blazer 506, the entire in-memory state of a blazer is recomputed. While this occurs, the blazer 506 may still receive operations to process, but will not execute them prior to catching up to the state of the shard corresponding to the LSN at the time of the restart without risking returning incomplete data being served for query execution. To recover accepted changes to a shard after a blazer 506 restarts, the tabloid 508 which maintains the subject table provides a recovery target to the blazer 506 by embedding a maximum sequence number for every shard. Alternatively, the blazer 506 may track the maximum sequence number that can be serviced by the shard, in which case the blazer 506 gets the definition of assigned shards from the tabloid 508 and updates the maximum sequence number accordingly, at which point the blazer 506 can serve data for rows having a sequence number which is less than the maximum sequence number. For tabloids 508, the process used to restart a tabloid 508 is important given that LSNs for individual tables maintained by the tabloid 508 are not maintained anywhere other than in memory at the tabloid 508. To prevent re-use of an already applied LSN, the restart process for the tabloid 508 includes updating the LSN for a table to a sequence number beyond a maximum sequence number that has been durably used by a DML operation. The recovery workflow described above for blazers 506 is then triggered to allow the tabloid 506 to wait for the blazer 508 to catch up to that value.

In some implementations, rather than writing all rows of a batch of transaction insert operations into the write-ahead log 516, the batch may be packaged into a file for storage in the cold storage 514 and the name of the file may instead be recorded into the write-ahead log 516. The file may be keyed by the sequence number of the mutation and can be garbage collected once the sequence number has been pruned from the write-ahead log 516. Recording the name of the file rather than each of the rows of the batch insert reduces timing and bandwidth overheads and avoids write failures which may otherwise result from processing a transaction in chunks.

In some implementations, a recovery process performed by or for the data store management component 500 using the write-ahead log 516 may use data written to the cold storage 514. For example, and because data blocks are typically immutable once written, a given sequence number can be removed from the write-ahead log 516 once all of the blocks associated with it have been moved to storage. The tail of the write-ahead log 516 may then be pruned up to that sequence number. As such, during recovery, all blocks associated with sequence numbers which are less than or equal to a given sequence number may be read and then mutations with sequence numbers greater than that given sequence number may be applied against those blocks.

The data store management component 500 predicts the use by the query processing component 504 of certain datasets using recency information indicating how recently those datasets have been used for query execution by the query processing component. Data is made available by the data store management component 500 to the query processing component 504 with the lowest latency when that data is in a memory buffer (e.g., of a blazer 506) rather than a warm storage device (e.g., a local storage of a blazer 506) or the cold storage 514. However, a memory buffer has a finite size and therefore cannot store all data at all times. As will be described below, the data store management component 500 communicates with the query processing component 504 (e.g., based on both being included in a same data platform, such as the data platform 300) to determine what data to purge from a low-latency memory buffer based on recency information indicating how recently a given dataset has been used for query execution. Accordingly, the data store management component 500 is configured to purge ingested data from a memory buffer by moving it into a warm storage device, such as local storage at a blazer 506, or into the cold storage 514, based on recency information for the data. For example, the purging can include moving a dataset into warm storage based on recency information for the dataset indicating that the data has not been used within a first temporal threshold. In another example, the purging can include moving the dataset into the cold storage 514 based on the recency information indicating that the data has not been used within a second temporal threshold greater than the first temporal threshold. Aside from predicting the use of certain datasets, the data store management component 500 may also move data from warm storage or from the cold storage 514 into a low-latency memory buffer for use by the query processing component in response to a request for that data from a compute node of a query execution pipeline implemented using the query processing component 504.

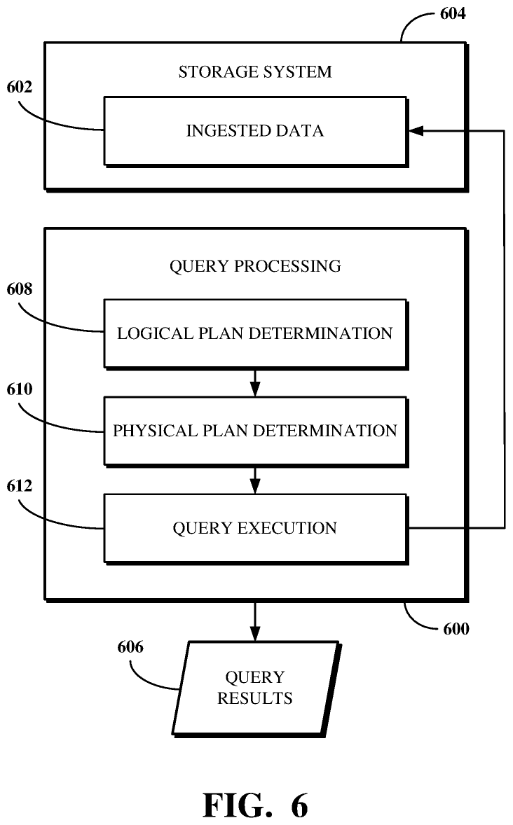

FIG. 6 is a block diagram of an example of a query processor component 600 of a data platform. For example, the query processor component 600 may be the query processor component 308 of the data platform 300 shown in FIG. 3. The query processor component 600 uses a query execution pipeline to access ingested data 602 within a storage system 604. The ingested data 602 is data which was prepared for use by a data store management component, which may, for example, be the data store management component 304 shown in FIG. 3. Query results 606 produced by the query execution may then be stored, used for analytical monitoring, or otherwise further processed or used.

The query processing component 600 includes a logical plan determination component 608, a physical plan determination component 610, and a query execution component 612. The logical plan determination component 608 processes a query (e.g., generated by the query generation component 310 shown in FIG. 3 or otherwise obtained by the query processing component 600) to determine a logical plan for executing the query. The physical plan determination component 610 processes the logical plan determined by the logical plan determination component 608 to determine a physical plan for executing the query. The query execution component 612 instantiates compute nodes (e.g., server nodes, such as application server nodes) according to the physical plan and executes the query by processing the ingested data 602 using those compute nodes to produce the query results 606.

The logical plan is a tree of relational operations that describes the computations required for the query to be executed. The logical plan determination component 608 determines the logical plan for executing the query by parsing the query and converting the expressions thereof into the tree of relational operations in a relational algebraic form. The tree of relational operations identifies faucets and turbines to use to execute the query at different levels of a query execution pipeline. A faucet is a temporary holding point for data. A turbine performs some part of the computation for query execution. Faucets and turbines are arranged on alternating levels of the query execution pipeline. A first level includes one or more source faucets which obtains a memory pointer usable to access the data to be processed for query execution within one or more blazers of a data store management component (e.g., the blazers 506 of the data store management component 500 shown in FIG. 5). For example, the memory pointer may be obtained using a memory mapping function such as mmap. A level below the one or more source faucets includes one or more turbines assigned to compute operations as part of the query execution which access the data using the memory pointer transmitted to them by the one or more source faucets. The next level includes another one or more faucets, which may be one or more final faucets that output the query results 606 where there are no further downstream turbines, or one or more downstream faucets that obtain local results from the first turbine level and passes those results to a next downstream turbine level, thereby decoupling those upstream and downstream turbines. In either case, the final level of the query execution pipeline includes one or more final faucets. The tree of relational operations describes the computations required to execute the query at various levels as well as the turbines which will be used to perform those computations. In some example, a logical plan may be a Jsonnet expression which can be compiled down to JSON-encoded protocol buffers.

The particular number of turbines or faucets in a given level and the number of turbine and faucet levels in the query execution plan are thus based on the logical plan. The logical plan determination component 612 determines the physical plan for the query based on one or more of the datasets to be used for the query, the amount of data from those datasets to be processed for the query execution, and the types of operations (e.g., joins, aggregations, etc.) to be performed as part of the query execution. For example, the logical plan determination component 612 may use properties of tables maintained by the data store management component (e.g., schema, sharding data, and LSNs) to determine the turbines and faucets of a query execution pipeline. In some cases, the logical plan determination component 612 may translate splits enumerated for a table to determine assignments for the logical plan.

For example, for a query including a global aggregation operation involving a single, large dataset, the physical plan may indicate to instantiate a single source faucet to deliver a memory pointer for accessing the dataset, multiple turbines in a next level which will each be assigned and retrieve a portion of the dataset, a single downstream faucet that collects the local results from those multiple turbines, a single downstream turbine in the next level below the downstream faucet that performs a merge operation to aggregate the local results, and a single final faucet in the last level.

In another example, for a query including a grouped aggregation operation in which a single, large dataset is aggregated based on some grouping, the physical plan is similar to that described above for the global aggregation operation where the cardinality of the grouping is small; however, where the cardinality of the grouping is instead large, multiple turbines may be present in the second turbine level to improve the parallel processing efficacy of the query execution turbine at the merge stage.

In yet another example, for a query including a pre-sharded grouping operation (a sub-class of a grouped aggregation operation in which a dataset is physically sharded on a subset of the grouping key and the physical sharding refers specified a layout of the various pieces of the bounded or unbounded collection of data of the dataset within a physical node cluster), records for a group are limited to reside in a single physical shard such that each shard can be locally grouped without a final merge step as described in the above global and grouped aggregation examples. Multiple source faucets are used to deliver portions of the physically sharded data to certain of multiple turbines, with the caveat that the accuracy of results produced using this query execution pipeline is based on those source faucets pushing data to their respective turbines only from a single corresponding physical shard of the dataset. The final level thus includes a same number of faucets as the first level.

Other examples of operations which may be processed by a query execution pipeline including nodes instantiated based on a physical plan for a query include, but are not limited to, windowed grouping operations and grouped aggregation operations with joins, such as replicated (e.g., unbounded-bounded) join operations, co-sharded join operations, distributed join operations, outer join operations, join operations with changing dimension tables, and unbounded-unbounded join operations.

The physical plan includes a network of compute nodes to be instantiated as the faucets and turbines within the query execution pipeline. The physical plan determination component 610 determines the physical plan for the query execution based on the logical plan determined by the logical plan determination component 608. Determining the physical plan includes identifying compute nodes to instantiate as the turbines and faucets identified within the logical plan. The network of compute nodes instantiated based on a physical plan determined by the physical plan determination component 610 is scalable based on the specific computational requirements for a query as set forth in its logical plan. A compute node identified for instantiating a faucet or turbine according to the physical plan may be a device or virtual machine which implements a blazer that stores the ingested data 602 or another device or virtual machine. In some implementations, the logical plan determination component 608 and the physical plan determination component 610 may be combined into a single component.

The query execution component 612 instantiates the faucets and turbines of the logical plan determined by the logical plan determination component 608 on compute nodes determined by the physical plan determination component 610 and performs query execution against the query associated with the physical plan using those faucets and turbines. A source faucet of the query execution pipeline is given a mapping to a memory location within the storage system 604 at which data to use for the query execution can be retrieved. The source faucet also generates a watermark to use for the query execution. The watermark is an element that indicates a measure of progress of the query execution pipeline in processing the data for the query. For example, the watermark may be a binary value, an integer value, or a float value. Turbines use the watermark to determine how much of the data they have processed. The watermark is transmitted from the source faucet to each downstream turbine and faucet on a level-by-level basis based on the completion of data collection or processing at a given node. The completion of the results received by a final faucet at a final level of the query execution pipeline, and thus the outputting of the query results 606, may be determined based on the watermark being received by that final faucet.

The specific processing of data by and transmission of watermarks between nodes of a query execution pipeline may differ in some ways based on whether the query to be executed by the query execution component 612 is a batch query or a streaming query. For batch query execution, the faucets and turbines are instantiated according to the physical plan. A source faucet binds a LSN for the subject dataset from the tabloid which maintains the table storing the dataset to determine the data associated with that LSN (e.g., the ingested data 602 or data including the ingested data 602). The source faucet is given a pointer to a location in a memory buffer (e.g., of a blazer) at which data of that dataset according to the LSN can be retrieved. The source faucet also generates a watermark, which may, for example, be a binary variable or an integer value. The source faucet transmits the pointer and the watermark to each turbine in the next level of the query execution pipeline. For example, the source faucet may transmit a copy of the watermark to each turbine. Each of the turbines retrieves a portion of the data using the memory pointer and performs some computation on the data portion based on the logical and physical plans. Each of the turbines transmits is computed data and the watermark (e.g., the copy it received) to a downstream faucet. Where the downstream faucet is the final faucet, the downstream faucet waits until it has received the watermark (and thus the computed data) from each turbine before outputting the final results as the query results 606. Alternatively, where the downstream faucet is not the final faucet, the downstream faucet may in some cases transmit computed data received from an upstream turbine to one or more downstream turbines at a next level of the query execution pipeline, but waits to transmit the watermark to those downstream turbines until after it has received the watermark from each of the upstream turbines. This is because the transmission of the watermark from an upstream turbine indicates that the turbine has finished processing the data it obtained and thus that no further results will be obtained from that turbine. Each turbine may finish its computations simultaneously or at different times. The downstream faucet enumerates the upstream turbines and thus knows how many turbines are expected to transmit data and watermarks. The downstream faucet eventually receives the watermark from each upstream turbine and transmits the watermark (e.g., copies thereof) to each downstream turbine along with any local results from the upstream turbines not yet provided to the downstream turbines. The downstream turbines operates as the upstream turbines by computing the data and transmitting the computed data and the watermark they obtained to a further downstream faucet. The process concludes once the final faucet receives the watermark from each turbine at the level above it, at which point the query results 606 are output and the faucets and turbines are terminated.

For streaming query execution, the process is largely similar, except that it repeats on some time interval basis based on newly ingested data, and the watermarks are used to indicate the completion of a partial result set corresponding to a certain time interval of data. A source faucet binds a LSN corresponding to a specific time interval for the subject dataset from the tabloid which maintains the table storing the dataset to determine the data associated with that LSN (e.g., the ingested data 602 or data including the ingested data 602). The source faucet is given a pointer to a location in a memory buffer (e.g., of a blazer) at which data of that dataset according to the LSN can be retrieved. The source faucet generates a watermark which may, for example, have a value mapped to the specified time interval corresponding to the LSN. The watermark and data are then processed between the levels of the query execution pipeline as described above to ultimately obtain a final result for that specified time interval. For example, the transmission of a watermark from a faucet to a turbine may indicate to that turbine that no further data will be used for the specified time interval. The final results are aggregated against pre-existing results from earlier time intervals. The source faucet then binds a new LSN corresponding to a next time interval for the subject dataset and generates a new watermark which may, for example, have a value mapped to that next time interval. The process repeats until the faucets and turbines are terminated.

As described above, a turbine may generally process data as soon as it receives it from an upstream faucet. However, in some cases, a turbine may wait to process data until after the watermark has been transmitted from all upstream turbines and faucets. For example, in the case of a replicated join performed against two datasets in which a first source faucet transmits a memory pointer for a first, unbounded dataset and a first watermark and a second source faucet transmits a memory pointer for a second, bounded dataset and a second watermark, a first level of turbines immediately downstream from the source faucets may access the respective data for join and local grouping processing. However, the packets from the first dataset may in at least some cases only be processed by a turbine of that first level once the watermark from the second source faucet has been received by that turbine. This is because the turbine only needs some of the data from the first dataset due to it being unbounded but needs all of the data from the second dataset due to it being bounded, and thus the receipt of the watermark indicates that the hash-table now fully reflects the contents of the second dataset as of some LSN for the subject table.

Similarly, a downstream faucet may generally transmit local results from upstream turbines to downstream turbines as soon as the local results become available to it. However, in some cases, a downstream faucet may wait to transmit local results from upstream turbines to downstream turbines. For example, in the context of a streaming query execution, data for a current time interval may still be under compute by one or more turbines while or after a source faucet binds a new LSN for data corresponding to a next time interval. In such a case, a downstream faucet may delay transmission of local results received from upstream turbines for that next time interval corresponding to the new LSN to its downstream turbines until those downstream turbines have completed processing of the data for the current time interval.

In some implementations, rather than transmitting a memory pointer to turbines, a source faucet may use a memory pointer to retrieve data from a blazer and thereafter transmit the retrieved data to the turbines in the next level of the query execution plan. In such a case, the turbines receive the watermark from the source faucet based on the turbines having received all of the data necessary for computation thereat from the source faucet.

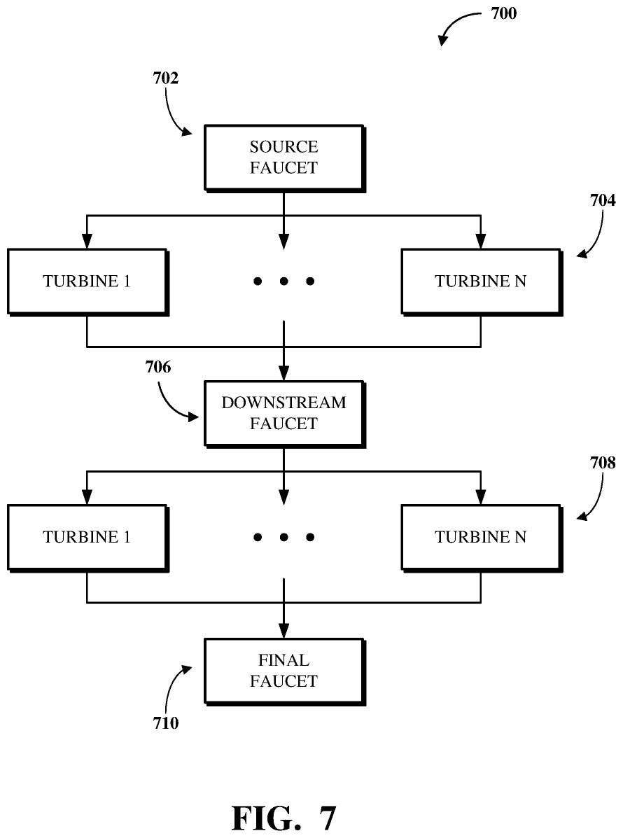

FIG. 7 is a block diagram of an example of a query execution pipeline 700, which includes faucets and turbines instantiated based on a physical plan determined, for example, by the physical plan determination component 610 shown in FIG. 6. As shown, a first level 702 of the query execution pipeline 700 includes a single source faucet which has a pointer to a location in a memory buffer at which data usable to execute a query can be retrieved and which generates or otherwise obtains a watermark. A second level 704 of the query execution pipeline 700 includes one or more turbines (labeled as turbines 1 through N in which N is an integer greater than or equal to 1) that receive the watermark and the pointer from the source faucet and which access the memory buffer at the location identified by the pointer to retrieve and perform some computation against at least a portion of the data. A third level 706 of the query execution pipeline 700 includes one downstream faucet to which receives the watermark and local results computed by the turbines of the second level 704 from each of those turbines. A fourth level 708 of the query execution pipeline 700 includes one or more turbines (labeled as turbines 1 through N in which N is an integer greater than or equal to 1) that receive the local results and the watermark from the downstream faucet of the third level 706 and perform some computation against the local results. A fifth level 710 of the query execution pipeline 700 includes a final faucet that receives the local results and watermark from each of the turbines of the fourth level 708 and outputs those local results as query results (e.g., the query results 606 shown in FIG. 6). Although two levels of turbines and one level of downstream faucets are shown, other numbers or arrangements of levels may be used with the query execution pipeline 700.

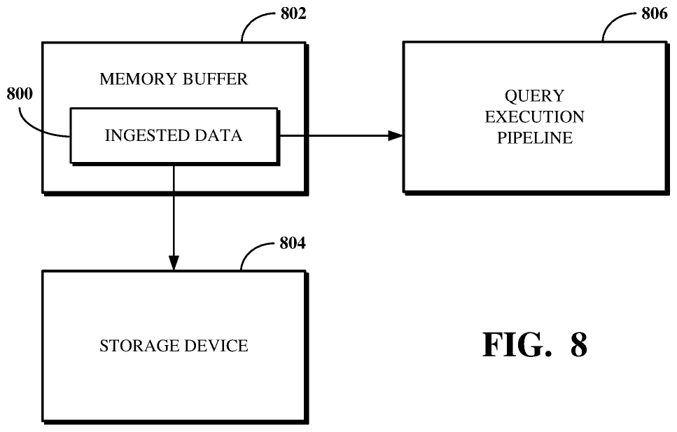

FIGS. 8-10 are block diagrams which illustrate low-latency capabilities of a data platform, for example, the data platform 300 shown in FIG. 3. The in-memory state of data obtained by a data store management component of a software platform, for example, the data store management component 500 shown in FIG. 5, enables low-latency access to that data by a query execution pipeline which includes compute nodes for executing a query, for example, the query execution pipeline 700 shown in FIG. 7. This low-latency access reduces latencies otherwise introduced by the data ingestion process, making data available more quickly for query execution and thus for analytical monitoring and alerting. The low-latency access further optimizes certain operations performed as part of a query execution process, such as joins between datasets, based on in-memory storage of certain data involved in the joins.

FIG. 8 is a block diagram of an example of parallel processing of ingested data 800 for query processing and storage. The ingested data 800 is data which has recently been obtained at and at least partially ingested by a data store management component, such as the data store management component 500. The ingested data 800 is in a memory buffer 802, which may, for example, be a memory buffer of a blazer of the data store management component, prior to the writing of the ingested data 800 to a storage device 804, such as the cold storage 514 shown in FIG. 5. The ingested data 800 is made available to a query execution pipeline 806, such as a query execution pipeline used by the query processing component 600 shown in FIG. 6, while the ingested data 800 remains in the memory buffer 802 and without requiring creation of a copy of the ingested data 800. As such, data processing, analytical alerts, and the like which are based on query results output from the query execution pipeline 806 based on the ingested data 800 are not contingent upon the ingested data 800 first being written to the storage device 804. Rather, the ingested data 800 may either be written to the storage device 804 after or in parallel with the retrieval of the ingested data 800 by a compute node of the query execution pipeline 806. In some implementations, a daemon service of a storage system which stores data for use by the query execution pipeline 806 may be co-located with the query processing component 806 and provide ingested data to the query processing component 806 without requiring a copy of that ingested data to first be made.

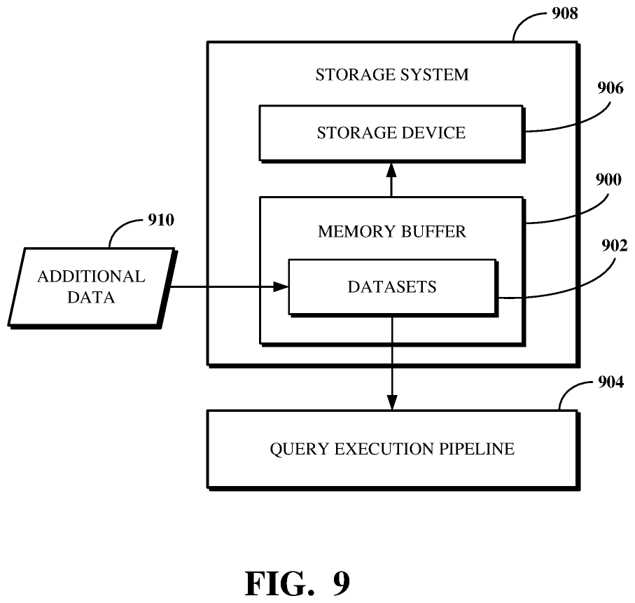

FIG. 9 is a block diagram of an example of buffer storage of static datasets for query operation optimization. Query operation optimizations are realized by the storage of a static dataset in a memory buffer 900, which may, for example, be the memory buffer 802 shown in FIG. 8. In particular, data of datasets which are determined to be static datasets may be maintained in the memory buffer 900 while data of datasets determined to not be static datasets may be purged from the memory buffer 900 to a warm or cold storage. A static dataset generally is a dataset which either does not change, is subject to infrequent change, or is less likely to change as compared to other datasets being joined with the static dataset. A dataset may be determined to be a static dataset based on one or more characteristics, including the dataset being a dimensional table, the dataset being determined to be less likely to change than another dataset, or the dataset having fewer records of data than another dataset.

As shown, the memory buffer 900 stores datasets 902 including data corresponding to the static dataset as a first dataset and data corresponding to a second dataset. The memory buffer 900 is a low-latency buffer used for low-latency access to and processing of the stored datasets 902. A query, for example, the query 404 shown in FIG. 4, may be executed using a query execution pipeline 904, which may, for example, be the query execution pipeline 806 shown in FIG. 8. The query includes a join operation between the first dataset and the second dataset stored in the memory buffer 900. Executing the query thus includes producing output (e.g., the query results 606 shown in FIG. 6) using the datasets 902 stored in the memory buffer 900.

Following execution of the query, data corresponding to the first dataset is maintained in the memory buffer 900 and data corresponding to the second dataset is purged from the memory buffer 900 based on a determination that the first dataset is a static dataset and a determination that the second dataset is not a static dataset. In particular, the second dataset is moved out of the memory buffer 900 to a storage device 906 of a storage system 908 which includes the memory buffer 900. For example, the storage device 906 may be a non-volatile storage device, such as the storage device 804 shown in FIG. 8. The storage system 908, which may, for example, be the storage system 604 shown in FIG. 6, is a tiered system of storage units managed by the data store management component, such as described with respect to FIG. 5 as including a first tier (e.g., memory buffers), a second tier (e.g., warm storage), and a third tier (e.g., cold storage). For example, the storage device 906 may be a storage device of the second tier or of the third tier.

Various query operation optimizations are possible using a static dataset maintained in the memory buffer 900. The query operation optimizations refer to operations performable by executing one or more queries against data including the static dataset while it is in the memory buffer 900. Examples of such operations include, without limitation, incremental joins computed by re-executing a previously executed query against the static dataset and additional data obtained after the earlier execution of the query, joins other than incremental joins computed by combining output from a previous query execution and output from the execution of the same or a different query against a different dataset, and aggregations computed by executing the same or a different query against the static dataset.

Incremental join optimizations refer to the use of the static dataset in the memory buffer 900 to compute an incremental join between that static dataset and additional data 910 corresponding to the dataset which was purged from the memory buffer 900. Because the earlier execution of the query computed a join between the two datasets and because only one of those datasets has changed as a result of the additional data 910, a full join does not need to be re-computed based on the additional data 910. Rather, an incremental join can be performed against the static dataset and the additional data 910 and the results of that incremental join can be aggregated with the results of the join computed by the earlier execution of the query. Such incremental join optimizations are enabled by a data store management component which controls the storage of datasets between the storage system 908, for example, the data store management component 500 shown in FIG. 5, having visibility into the data used by a query processing component which uses the query execution pipeline 904. For example, the inclusion of the data store management component and the query processing component within the same data platform may enable the incremental join optimizations.

In some cases, however, additional data corresponding to the static dataset may be obtained. In such a case, the full join between the static dataset and the other dataset may be re-computed, such as due to the change to the static dataset and the other dataset not being in the memory buffer 900.

In some implementations, after the earlier execution of the query to compute the join between the datasets, the query may be rewritten in some way to use pre-computed join indices. For example, the pre-computed join indices may refer to join results obtained from the earlier execution of the query. The inclusion of pre-computed join indices may improve join operations to be re-computed during subsequent executions of the query, such as by limiting resource expenditure and latency otherwise involved in re-computing the join indices.

Join optimizations other than those for incremental joins refer to the use of the static dataset in the memory buffer 900 and another dataset. In particular, whereas an incremental join is computed for a first dataset as a static dataset and additional data obtained for a second dataset as a non-static dataset, other joins may be computed for the first dataset and a third dataset regardless of whether additional data for the third dataset has been obtained since an earlier execution of a query against the first dataset. Aggregation optimizations refer to the use of output previously computed by executing a query against the static dataset in the memory buffer 900 and the use of further output computed by re-executing the same query or a different query against the static dataset.

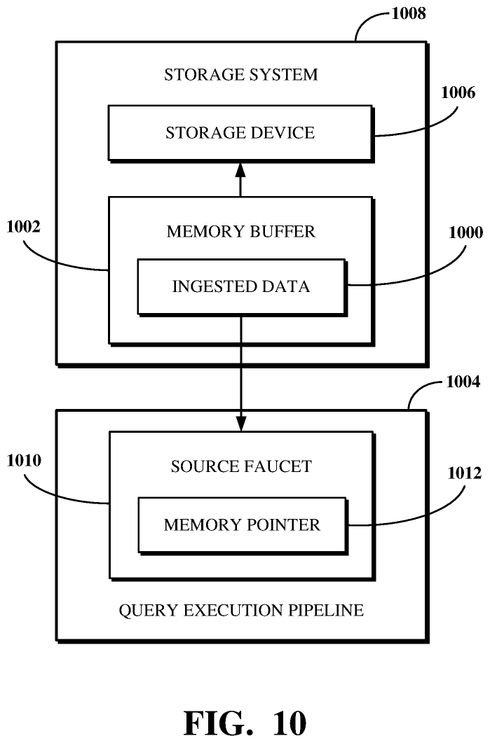

FIG. 10 is a block diagram of an example of access to ingested data 1000 within a memory buffer 1002 for query execution. For example, the ingested data 1000 and the memory buffer 1002 may respectively be ingested data 800 and the memory buffer 802 shown in FIG. 8. A query execution pipeline 1004, which may, for example, be the query execution pipeline 806 shown in FIG. 8, through one or more compute nodes thereof is able to access the ingested data 1000 within the memory buffer 1002 in response to the ingestion of the ingested data 1000 by a data store management component, for example, the data store management component 500 shown in FIG. 5.

In particular, the design of the data store management component and the data platform which includes it, for example, the data platform 300 shown in FIG. 3, enables newly arrived data such as the ingested data 1000 to be made available for query execution without first writing the data to storage and without first creating a copy of the data. This design enables immediate access to the newly arrived data for query execution, which may result in immediate analytical alerting and monitoring based on the newly arrived data with minimal ingestion and processing latency.

Thus, access to the ingested data 1000 within the memory buffer 1002 is made available to those compute nodes of the query execution pipeline 1004 before the ingested data 1000 is written to storage (e.g., a storage device 1006, which may, for example, be the storage device 804 shown in FIG. 8 and is of a storage system 1008, which may, for example, be the storage system 604 shown in FIG. 6) and without requiring creation of a copy of the ingested data 1000. The compute nodes of the query execution pipeline 1004 which are able to access the ingested data 1000 within the memory buffer 1002 may, for example, include a source faucet 1010. For example, the source faucet 1010 may use a memory pointer 1012 which identifies a memory location in the memory buffer 1002 at which the ingested data 1000 is stored to access the ingested data 1000 without requiring a creation of a copy of the ingested data 1000 in an additional memory location in the memory buffer 1002.

At some point after the query execution pipeline 1004 accesses the ingested data 1000 within the memory buffer 1002 for query execution, the data store management component uses recency of use information for a dataset corresponding to the ingested data to determine to purge the ingested data 1000 from the memory buffer 1002, such as by moving the ingested data 1000 to the storage device 1006. As has been described above, the memory buffer 1002 is of a limited size and thus cannot store all data for all datasets. Rather, to maintain both low latency in ingested data becoming available for query execution and in query execution itself, certain data is moved out of the memory buffer 1002 to make space available for data which is predicted to be used imminently by the query execution pipeline 1004.

Accordingly, the data store management component may ingest, as the ingested data 1000, data from one or more data sources directly into the memory buffer 1002, as a low-latency memory buffer. In response to ingesting the data, the query execution pipeline 1004, such as by the source faucet 1010 thereof, may access the ingested data in the memory buffer 1002 to execute a query without requiring creation of a copy of the ingested data 1000. Subsequent to executing the query, the data store management component may purge the ingested data 1000 from the memory buffer 1002 based on a recency of use of a dataset corresponding to the ingested data 1000 for query execution.

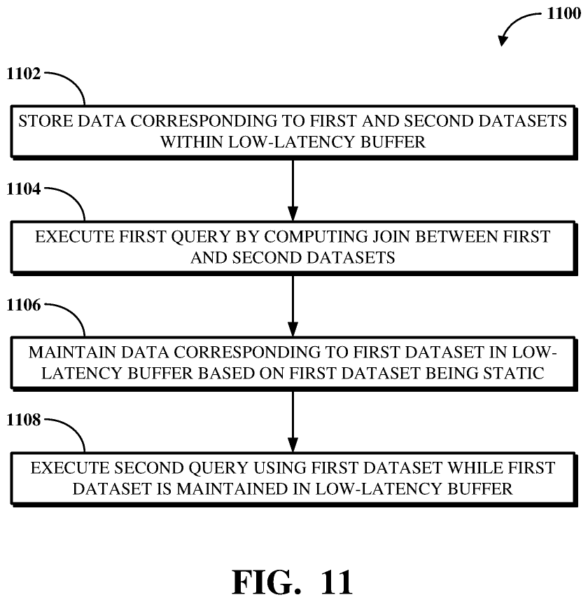

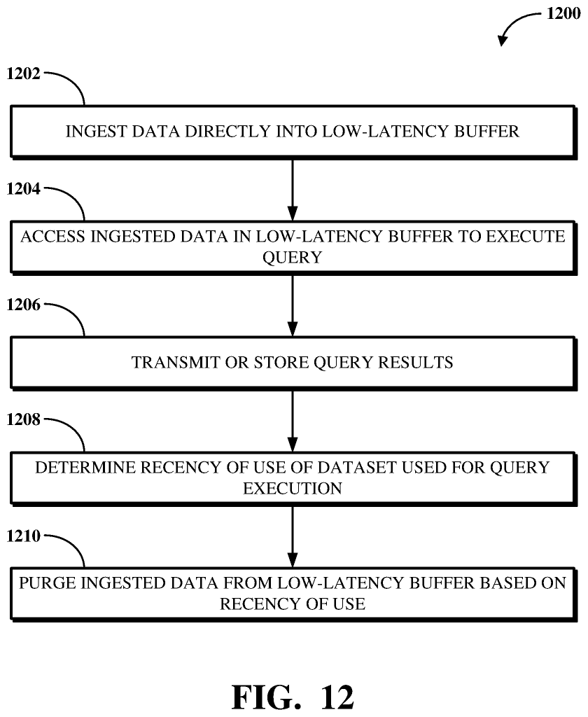

To further describe some implementations in greater detail, reference is next made to examples of techniques which may be performed by or using a system for low-latency buffer storage of static datasets for query operation optimization. FIG. 11 is a flowchart of an example of a technique 1100 for low-latency buffer storage of static datasets for query operation optimization. FIG. 12 is a flowchart of an example of a technique 1200 for low-latency access to ingested data for query execution.

The technique 1100 and/or the technique 1200 can be executed using computing devices, such as the systems, hardware, and software described with respect to FIGS. 1-10. The technique 1100 and/or the technique 1200 can be performed, for example, by executing a machine-readable program or other computer-executable instructions, such as routines, instructions, programs, or other code. The steps, or operations, of the technique 1100 and/or the technique 1200 or another technique, method, process, or algorithm described in connection with the implementations disclosed herein can be implemented directly in hardware, firmware, software executed by hardware, circuitry, or a combination thereof.

For simplicity of explanation, the technique 1100 and the technique 1200 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 11, the technique 1100 for low-latency buffer storage of static datasets for query operation optimization is shown. At 1102, data corresponding to a first dataset and data corresponding to a second dataset are stored within a low-latency buffer. The low-latency buffer may, for example, be a memory buffer of a blazer or a memory buffer of another device or virtual machine.

At 1104, a first query is executed by computing a join between the first and second datasets. In particular, executing the first query by computing the join between the first dataset and the second dataset includes producing a first, original output using the data corresponding to the first dataset and the data corresponding to the second dataset that is stored in the low-latency buffer. For example, the data corresponding to the first and second datasets may be accessed by one or more compute nodes of a query execution pipeline using memory pointers identifying locations of those data in the low-latency buffer.

At 1106, following execution of the first query, data corresponding to the first dataset is maintained within the low-latency buffer and data corresponding to the second dataset is purged from the low-latency buffer. The data corresponding to the first dataset is maintained within the low-latency buffer based on a determination that the first dataset is a static dataset. The data corresponding to the second dataset is purged from the low-latency buffer based on a determination that the second dataset is not a static dataset. In some implementations, the first dataset may be determined to be a static dataset based on the first dataset being a dimensional table. In some implementations, the first dataset may be determined to be a static dataset based on the first dataset being less likely to change than the second dataset. In some implementations, the first dataset may be determined to be a static dataset based on the first dataset having fewer records of data than the second dataset.

At 1108, a second query is executed using the first dataset to produce a second output while data corresponding to the first dataset is maintained in the low-latency buffer. The second query may be the same as or different from the first query. The second query is executed to perform a query operation against the first dataset in which the query operation is optimized by the in-memory state of the first dataset. In some cases, the second query may involve computing a join between the first dataset and a third dataset. In some cases, the second query may involve computing an aggregation involving data of the first dataset. In some cases, the second query may involve computing an incremental join between the first dataset and additional data corresponding to the second dataset obtained after the execution of the first query. For example, the additional data may be ingested from a data source into the low-latency buffer without requiring that the additional data first be stored in a non-volatile, long-term storage device, such as a warm storage or a cold storage. For example, the additional data may be stored in the non-volatile storage device in parallel with the ingestion of the additional data into the low-latency buffer.

Where the second query involves such an incremental join, the second output produced as a result of the computation may be an incremental output which can then be combined with the first output. For example, re-executing the query may include accessing the additional data using a pointer to the low-latency buffer at which the additional data is stored without requiring creation of a copy of the additional data in an additional memory location. For example, the pointer may identify a memory location in the low-latency buffer.

For example, the technique 1100 may be performed by a system including a relational data store configured to store a first dataset within a low-latency buffer prior to an original output of a query and to obtain additional data corresponding to a second dataset subsequent to the original output of the query, and a query execution pipeline configured to obtain the original output of the query by computing a join between the first dataset and the second dataset and to obtain an updated output while limiting a re-computation of the join between the first dataset and the second dataset by combining the original output with an incremental output of the query obtained by computing a join between the first dataset and the additional data of the second dataset while the first dataset remains in the low-latency buffer.

In some implementations, the query may be re-executed at the device or virtual machine which includes the low-latency buffer. In some implementations, the query may be re-executed at a device or virtual machine other than a device or virtual machine which includes the low-latency buffer. For example, the pointer may identify both the other device or virtual machine as well as the in-memory location of the additional data. In some implementations, the query may be a streaming query and the additional data may be used within a query execution pipeline instantiated before the additional data is obtained.

Referring next to FIG. 12, the technique 1200 for low-latency access to ingested data for query execution is shown. At 1202, data is ingested directly into a low-latency buffer. The low-latency buffer may, for example, be a memory buffer of a blazer or a memory buffer of another device or virtual machine. The data is ingested from one or more data sources. For example, ingesting the data from the one or more data sources can include updating sequence numbers of tables maintained by tabloids according to rows being written into shards of those tables maintained by blazers within a same cluster as the tabloids and by the ingested data being stored in the low-latency buffer as a result of the update.

At 1204, the ingested data is accessed in the low-latency buffer to execute a query. The query is executed using a query execution pipeline, which includes one or more compute nodes instantiated based on a query plan for a query, in which the one or more compute nodes use pointers to the ingested data within a data store associated with the low-latency buffer (e.g., a relational data store) to execute the query. For example, a source faucet of a query execution pipeline may access the ingested data using a memory pointer identifying a location of the ingested data within the low-latency buffer. The ingested data is accessed in the low-latency buffer in response to the ingestion of the data directly into the low-latency buffer, such as to enable immediate or near immediate access to that data for query execution upon that data being obtained by the data store which stores it. The ingested data is accessed within the low-latency buffer without requiring creation of a copy of the ingested data.

At 1206, query results produced by the query execution are transmitted or stored. For example, the query results may be written to new rows of shards of one or more tables. In another example, the query results may be used for analytical monitoring or alerting purposes, such as to inform a user of a data platform as to those query results or the ingested data itself.

At 1208, a recency of use of a dataset corresponding to the ingested data is determined. The recency of use of the dataset is determined based on information identifying a last time that the dataset was used for query execution, such as by the query execution pipeline which executed the query.

At 1212, the ingested data is purged from the low-latency buffer based on the recency of use. For example, the ingested data may be moved into a warm or cold storage device based on the recency of use of the dataset corresponding to the ingested data for query execution. In some implementations, the purged data may later be moved from the warm or cold storage device back to the low-latency buffer to permit access to the data by a compute node of the query execution pipeline, such as in response to a request by that compute node for data corresponding to the purged dataset.

For example, the technique 1200 may be performed by a system including a relational data store configured to ingest data from one or more data sources directly into a low-latency memory buffer, and a query execution pipeline including at least one compute node that is configured to access the ingested data in the low-latency memory buffer for query execution responsive to the ingestion without requiring creation of a copy of the ingested data, in which the relational data store is configured to purge the ingested data from the low-latency memory buffer based on a recency of use of a dataset corresponding to the ingested data by the query execution pipeline.

In some such implementations, the upstream faucet may transmit, to each of the one or more downstream turbines, a watermark indicating that all of the ingested data has been made available to the one or more downstream turbines, in which a downstream faucet receives the watermark from ones of the one or more downstream turbines responsive to the ones of the one or more downstream turbines completing processing of the ingested data. In some such implementations, the upstream faucet may obtain additional data ingested by the data store into the low-latency buffer on a periodic basis independent of an aggregation time period associated with the query.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, Ruby, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to hardware, mechanical or physical implementations, but can include software routines implemented in conjunction with hardware processors, etc. Likewise, the terms “system” or “tool” as used herein and in the figures, but in any event based on their context, may be understood as corresponding to a functional unit implemented using software, hardware (e.g., an integrated circuit, such as an application specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus, comprising:
a memory storing instructions; and
a processor configured to execute the instructions to:
store data corresponding to a first dataset and data corresponding to a second dataset within a low-latency buffer;
execute a first query by computing a join between the first dataset and the second dataset to produce a first output using the data corresponding to the first dataset and the data corresponding to the second dataset that is stored in the low-latency buffer;
following execution of the first query, maintain data corresponding to the first dataset in the low-latency buffer and purge data corresponding to the second dataset from the low-latency buffer based on a determination that the first dataset is a static dataset and a determination that the second dataset is not a static dataset; and
execute a second query using the first dataset to produce a second output while the data corresponding to the first dataset is maintained in the low-latency buffer.

2. The apparatus of claim 1, wherein the second query involves computing an incremental join between the first dataset and additional data corresponding to the second dataset obtained after the execution of the first query.

3. The apparatus of claim 2, wherein the additional data is ingested from a data source into the low-latency buffer without requiring that the additional data first be stored in a non-volatile storage device.

4. The apparatus of claim 3, wherein the additional data is stored in the non-volatile storage device in parallel with the ingestion of the additional data into the low-latency buffer.

5. The apparatus of claim 3, wherein the instructions include instructions to:
combine the first output and the second output.

6. The apparatus of claim 3, wherein the instructions to execute the second query include instructions to:
access the additional data using a pointer to the low-latency buffer at which the additional data is stored without requiring creation of a copy of the additional data in an additional memory location.

7. The apparatus of claim 6, wherein the processor is in a first computing device, the low-latency buffer is implemented on a second computing device distinct from the first computing device, and the pointer identifies the second computing device and a location of the additional data in the low-latency buffer.

8. The apparatus of claim 2, wherein the query is a streaming query and the additional data is used within a query execution pipeline instantiated before the additional data is obtained.

9. The apparatus of claim 1, wherein the second query involves computing a join between the first dataset and a third dataset.

10. The apparatus of claim 1, wherein the first dataset is determined to be a static dataset based on one or more of the first dataset being a dimensional table, the first dataset being less likely to change than the second dataset, or the first dataset having fewer records of data than the second dataset.

11. A method, comprising:
storing a first dataset and a second dataset within a low-latency buffer;
obtaining a output of a first query by computing a join between the first dataset and the second dataset;
purging the second dataset from the low-latency buffer after obtaining the output of the first query; and
obtaining a output of a second query using the first dataset while the first dataset is maintained in the low-latency buffer.

12. The method of claim 11, wherein the first dataset is maintained in the low-latency buffer based on a determination that the first dataset is a static dataset.

13. The method of claim 12, wherein the second dataset is purged from the low-latency buffer based on the first dataset being the static dataset.

14. The method of claim 11, wherein the second query involves using additional data corresponding to the second dataset obtained after purging the second dataset from the low-latency buffer, and wherein the additional data is ingested from a data source into the low-latency buffer without requiring that the additional data first be stored in a long-term storage device.

15. The method of claim 14, wherein the second query indicates to compute an incremental join between the first dataset and the additional data.

16. A system, comprising:
a relational data store configured to store a first dataset and a second dataset within a low-latency buffer prior to an output of a first query and purge the second dataset from the low-latency buffer after the output of the first query; and
a query execution pipeline configured to obtain the output of the first query by computing a join between the first dataset and the second dataset and to obtain an output of a second query using the first dataset while the first dataset is maintained in the low-latency buffer.

17. The system of claim 16, wherein the second query involves computing an incremental join between the first dataset and additional data corresponding to the second dataset obtained after the output of the first query, and wherein the additional data is ingested from a data source into the low-latency buffer without requiring that the additional data first be stored in a long-term storage device.

18. The system of claim 17, wherein the query execution pipeline is configured to access the additional data using a pointer to the low-latency buffer at which the additional data is stored without requiring a creation of a copy of the additional data in an additional memory location.

19. The system of claim 16, wherein the relational data store maintains the first dataset within the low-latency buffer and purges the second dataset from the low-latency buffer based on the first dataset being a static dataset.

20. The system of claim 19, wherein the first dataset is determined to be a static dataset based on one or more of the first dataset being a dimensional table, being less likely to change than the second dataset, or having fewer records of data than the second dataset.
